(19) United States
(12) Patent Application Publication
(10) Pub. No.: US 2017/0269515 A1
(43) Pub. Date: Sep. 21, 2017

(54) BELT DRIVING DEVICE, IMAGE FORMING APPARATUS, METHOD, AND COMPUTER-READABLE RECORDING MEDIUM

(71) Applicants: Masumi NAKAMURA, Kanagawa (JP); Satoshi UEDA, Ibaraki (JP); Akira KOBASHI, Kanagawa (JP)

(72) Inventors: Masumi NAKAMURA, Kanagawa (JP); Satoshi UEDA, Ibaraki (JP); Akira KOBASHI, Kanagawa (JP)

(73) Assignee: Ricoh Company, Ltd., Tokyo (JP)

(21) Appl. No.: 15/460,349

(22) Filed: Mar. 16, 2017

(30) Foreign Application Priority Data
Mar. 17, 2016 (JP) 2016-054513

(51) Int. Cl. G03G 15/01

(52) U.S. Cl. CPC G03G 15/1615

(57) ABSTRACT

A belt driving device that drives an endless belt, the belt driving device includes: circuitry configured to correct a belt position, which is the position of the endless belt in a width direction, to a set position; calculate an estimated life of the belt driving device based on correction time taken for the correction of the belt position; and output the estimated life.

### CROSS-REFERENCE TO RELATED APPLICATIONS

The present application claims priority under 35 U.S.C. §119 to Japanese Patent Application No. 2016-054513, filed on Mar. 17, 2016. The contents of which are incorporated herein by reference in their entirety.

### BACKGROUND OF THE INVENTION

1. Field of the Invention

The present invention relates to a belt driving device, an image forming apparatus, a method, and a computer-readable recording medium.

2. Description of the Related Art

A technique for correcting the deviation of the position of an intermediate transfer belt, which is used in an image forming apparatus, in a width direction has been known in the past. In the related art, a case in which a deviation cannot be corrected to a target in a predetermined time due to the failure or the like of a mechanism correcting a deviation is detected as a system error, and a user is notified of the detection of the system error in a case in which the system error is detected.

However, if a situation in which the operation of an apparatus is stopped (for example, the failure of the mechanism correcting a deviation) does not actually occur, a user is not notified of a system error in the related art.

Accordingly, a technique for calculating the life of a component to be worn, such as a gear, used in a mechanism correcting a deviation is proposed to predict the occurrence time of a situation in which the operation of an apparatus is stopped (for example, see Japanese Unexamined Patent Application Publication No. 2013-210506).

However, a factor, which causes the operation of the apparatus to stop, is not limited to the wear of the gear or the like. That is, in the technique of Japanese Unexamined Patent Application Publication No. 2013-210506, the operation of the apparatus may stop at an unexpected timing due to a factor other than the wear of the gear or the like.

In consideration of the above-mentioned circumstances, there is a need to provide a belt driving device, an image forming apparatus, a method, and a computer-readable recording medium having a program that can previously estimate a possibility that a situation in which the operation of an apparatus is stopped may occur and can further suppress the stop of the operation of the apparatus at an unexpected timing.

### SUMMARY OF THE INVENTION

According to exemplary embodiments of the present invention, there is provided a belt driving device that drives an endless belt, the belt driving device comprising: circuitry configured to correct a belt position, which is the position of the endless belt in a width direction, to a set position; calculate an estimated life of the belt driving device based on correction time taken for the correction of the belt position; and output the estimated life.

Exemplary embodiments of the present invention also provide an image forming apparatus including the above-described belt driving device.

Exemplary embodiments of the present invention also provide a method that is performed by a belt driving device that includes circuitry and drives an endless belt, the method comprising: correcting a belt position, which is the position of the endless belt in a width direction, to a set position, by the circuitry; calculating an estimated life of the belt driving device based on correction time, which is taken for the correction of the belt position, by the circuitry; and outputting the estimated life by the circuitry.

Exemplary embodiments of the present invention also provide a non-transitory computer-readable recording medium that contains a computer program that causes a computer of a belt driving device, which drives an endless belt, to execute: correcting a belt position, which is the position of the endless belt in a width direction, to a set position, calculating an estimated life of the belt driving device based on correction time, which is taken for the correction of the belt position, and outputting the estimated life.

### BRIEF DESCRIPTION OF THE DRAWINGS

FIG. 1 is a diagram illustrating the schematic configuration of an image forming apparatus according to a first embodiment;

FIG. 2A is a diagram illustrating the structure of a belt position detection sensor according to the first embodiment;

FIG. 2B is a diagram of the belt position detection sensor according to the first embodiment seen in a direction different from that of FIG. 2A;

FIG. 3A is a diagram illustrating a slit hole of the belt position detection sensor according to the first embodiment;

FIG. 3B is a diagram illustrating light-receiving elements of the belt position detection sensor according to the first embodiment;

FIG. 4A is a diagram illustrating an example of a positional relationship between the slit hole and the light-receiving elements of the belt position detection sensor according to the first embodiment;

FIG. 4B is a diagram illustrating an example, which is different from FIG. 4A, of a positional relationship between the slit hole and the light-receiving elements of the belt position detection sensor according to the first embodiment;

FIG. 4C is a diagram illustrating an example, which is different from FIGS. 4A and 4B, of a positional relationship between the slit hole and the light-receiving elements of the belt position detection sensor according to the first embodiment;

FIG. 5 is a diagram illustrating changes in output signals that are caused by a change in a positional relationship between the slit hole and the light-receiving elements of the belt position detection sensor according to the first embodiment;

FIG. 6 is a block diagram illustrating the schematic configuration of a belt driving device according to the first embodiment;

FIG. 7 is a block diagram illustrating the detailed configuration of the belt driving device according to the first embodiment;

FIG. 8 is a flow chart illustrating processing that is performed by a controller of the belt driving device according to the first embodiment;

FIG. 9 is a diagram illustrating a method of calculating an estimated life according to the first embodiment;

FIG. 10 is a diagram illustrating the time change of a control signal that is used in a second embodiment;

FIG. 11 is a flow chart illustrating processing that is performed by a controller of a belt driving device according to the second embodiment;

FIG. 12 is a flow chart illustrating processing that is performed by a controller of a belt driving device according to a modification of the second embodiment;

FIG. 13A is a diagram illustrating an example of belt ready time in a case in which a belt drive mode is not changed from the time of drive of previous time in a third embodiment;

FIG. 13B is a diagram illustrating an example of belt ready time in a case in which a belt drive mode is changed from the time of drive of previous time in the third embodiment;

FIG. 14 is a flow chart illustrating processing that is performed by a controller of a belt driving device according to a third embodiment;

FIG. 15 is a flow chart illustrating processing that is performed by a controller of a belt driving device according to a modification of the third embodiment;

FIG. 16 is a flow chart illustrating processing that is performed by a controller of a belt driving device according to a fourth embodiment;

FIG. 17 is a diagram illustrating the movement of a belt position to a belt stabilization position that is performed in a fifth embodiment; and

FIG. 18 is a flow chart illustrating processing that is performed by a controller of a belt driving device according to a fifth embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of a belt driving device, an image forming apparatus, a method, and a program will be described in detail below with reference to the accompanying drawings.

### First Embodiment

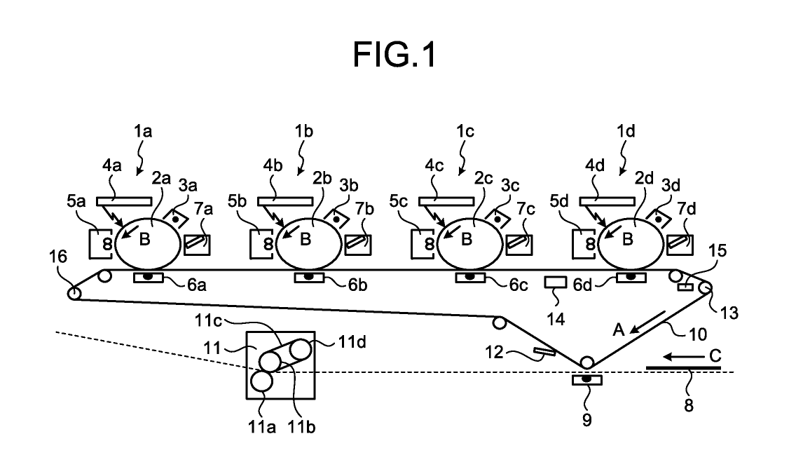

FIG. 1 is a diagram illustrating the schematic configuration of an image forming apparatus according to a first embodiment. A technique of the first embodiment can be applied to all of image forming apparatuses, such as a copying machine, a printer, a scanner, and a facsimile machine.

As illustrated in FIG. 1, an image forming apparatus according to a first embodiment is a tandem four-full color image forming apparatus. That is, the image forming apparatus according to the first embodiment includes four image forming units 1a, 1b, 1c, and 1d corresponding to four colors of yellow (Y), magenta (M), cyan (C), and black (K). These four image forming units 1a, 1b, 1c, and 1d are disposed along a traveling direction (a revolving direction, see an arrow A) of an intermediate transfer belt 10.

The image forming unit 1a includes a photoconductor drum 2a serving as an image bearer, a drum charger 3a, an exposure device 4a, a developing device 5a, a transfer unit 6a, and a cleaning device 7a. Likewise, the image forming units 1b to 1d include photoconductor drums 2b to 2d, drum chargers 3b to 3d, exposure devices 4b to 4d, developing devices 5b to 5d, transfer units 6b to 6d, and cleaning devices 7b to 7d, respectively.

The image forming units 1a to 1d form images having colors that are different from each other. For example, the image forming unit 1a forms an image having a yellow (Y) color, the image forming unit 1b forms an image having a magenta (M) color, the image forming unit 1c forms an image having a cyan (C) color, and the image forming unit 1d forms an image having a black (K) color.

When the photoconductor drum 2a receives a signal for instructing an image forming operation to start, the photoconductor drum 2a starts to rotate in the direction of an arrow B and continues to rotate until the image forming operation ends. When the photoconductor drum 2a starts to rotate, a high voltage is applied to the drum charger 3a and the surface of the photoconductor drum 2a is uniformly charged with negative charges. At this time, image data, which are converted into a dot image, are input as ON/OFF signals of the exposure device 4a, portions, which are irradiated with laser beams, and portions, which are not irradiated with laser beams, are formed on the surface of the photoconductor drum 2a by the exposure device 4a. That is, an electrostatic latent image corresponding to the image data, which are input to the image forming apparatus, is formed on the surface of the photoconductor drum 2a.

When the electrostatic latent image, which is formed on the photoconductor drum 2a, reaches a position facing the developing device 5a, toner charged with negative charges is attracted to a portion at which the charges are lowered on the photoconductor drum 2a. As a result, a toner image is formed. The toner image, which is formed on the photoconductor drum 2a, reaches the transfer unit 6a serving as primary transfer means, the toner image is transferred to the intermediate transfer belt (endless belt) 10, which rotates (revolves) in the direction of an arrow A, by the action of the high voltage applied to the transfer unit 6a. Meanwhile, even after the toner image passes by a transfer position (an image transfer portion), toner, which remains on the photoconductor drum 2a without being transferred, is removed by the cleaning device 7a and is supplied to the next image forming operation.

Subsequently to the image forming operation performed by the image forming unit 1a, the same image forming operation is also performed by the image forming unit 1b and a toner image formed on the photoconductor drum 2b is transferred to the intermediate transfer belt 10 by the action of a high voltage applied to the transfer unit 6b. At this time, a timing at which the image, which is formed by the image forming unit 1a and is transferred to the intermediate transfer belt 10, reaches the transfer unit 6b corresponds to a timing at which the toner image formed on the photoconductor drum 2b is transferred to the intermediate transfer belt 10. Accordingly, the toner images, which are formed by the image forming units 1a and 1b, overlap each other on the intermediate transfer belt 10. Then, when toner images, which are formed by the image forming units 1c and 1d, overlap each other on the intermediate transfer belt 10 likewise, a full-color image is formed on the intermediate transfer belt 10.

The intermediate transfer belt 10 is controlled based on at least one of the speed of a belt driving roller 13 and the surface speed of the intermediate transfer belt 10. The detection of the surface speed of the intermediate transfer belt 10 is performed by a scale detector 14 that determines the revolution of the intermediate transfer belt 10. The scale detector 14 determines the revolution of the intermediate transfer belt 10 by detecting a scale that is provided on the inside of the intermediate transfer belt 10.

Meanwhile, when the full-color image reaches a sheet transfer unit 9 serving as secondary transfer means, a sheet (recording medium) 8, which has been conveyed in the direction of an arrow C from a sheet feeding tray (not illustrated) of the image forming apparatus, reaches the sheet transfer unit 9 at the same time. Then, the full-color image formed on the intermediate transfer belt 10 is transferred to the sheet 8 by the action of a high voltage applied to the sheet transfer unit 9. After that, when the sheet 8 is conveyed to a fixing device 11, the unfixed toner image, which is present on the sheet 8, is pressed and heated by fixing means provided in the fixing device 11. Accordingly, the unfixed toner image on the sheet 8 is melted and fixed to the sheet 8. Here, the fixing device 11 includes a heating roller 11a, a pressure roller 11b, a fixing belt 11c, and a turning roller 11d.

On the other hands, after the full-color image passes by the sheet transfer unit 9, residual toner, which is not transferred, remains on the intermediate transfer belt 10 without being fixed. The residual toner is removed by a belt cleaning mechanism 12 and is supplied to the next image forming operation.

Here, the position of the intermediate transfer belt 10 in a width direction (hereinafter, referred to as a belt position) can be adjusted by a steering roller 16. The steering roller 16 is a roller that is driven so as to wind the intermediate transfer belt 10. Specifically, the steering roller 16 is driven by a steering motor 301 (not illustrated in FIG. 1) to be described below so as to move up and down or so as to be tilted, and achieves the adjustment of a belt position as a result of the up and down movement and tilting. Meanwhile, a belt position is detected by a belt position detection sensor 15. In the first embodiment, when the intermediate transfer belt 10 deviates in the width direction, the deviation of the intermediate transfer belt 10 is detected by the belt position detection sensor 15 and can be removed by the steering roller 16.

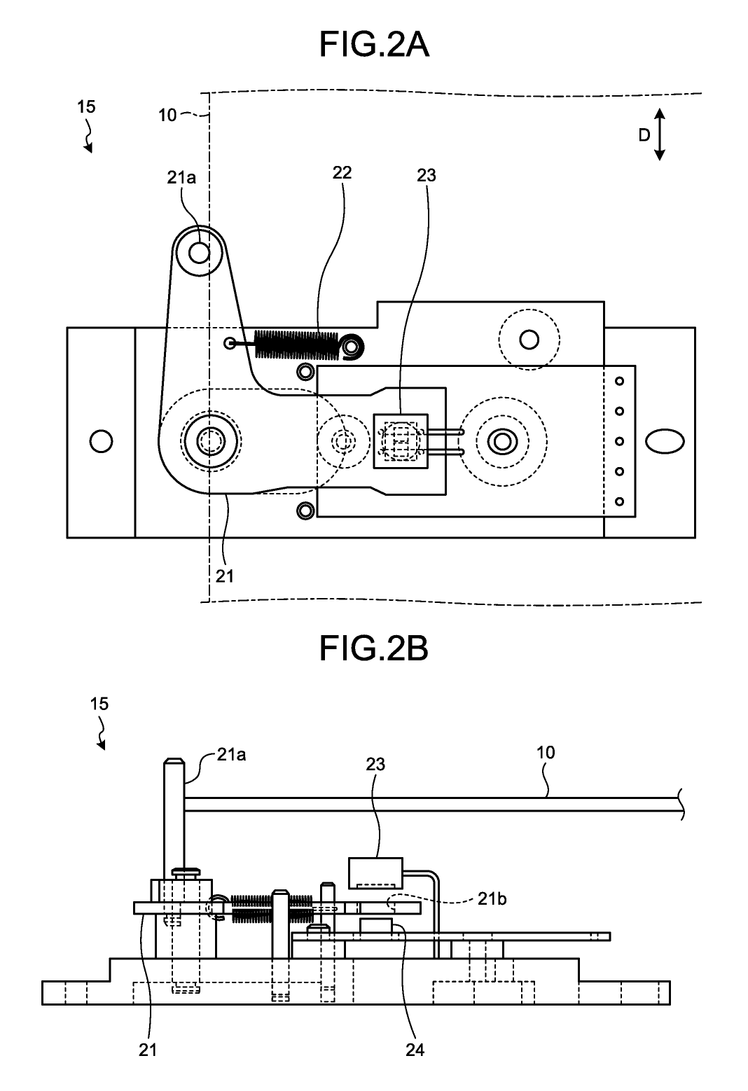

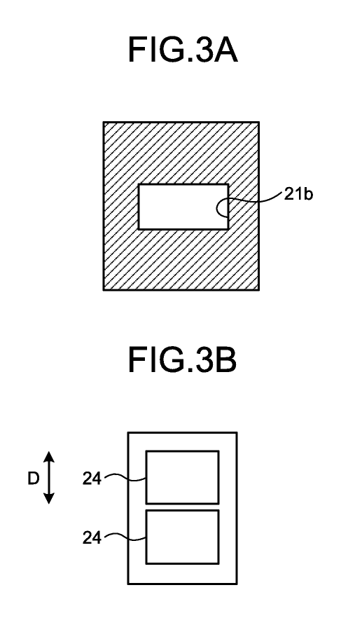

FIGS. 2A and 2B are diagrams illustrating the structure of the belt position detection sensor 15 according to the first embodiment. Further, FIG. 3A is a diagram illustrating a slit hole 21b of the belt position detection sensor 15 according to the first embodiment, and FIG. 3B is a diagram illustrating light-receiving elements 24 of the belt position detection sensor 15 according to the first embodiment.

As illustrated in FIGS. 2A and 2B, the belt position detection sensor 15 includes a contact member 21 that includes a pin 21a and a slit hole 21b. The pin 21a is disposed so as to be in contact with an end portion of the intermediate transfer belt 10. Further, the pin 21a is biased against the end portion of the intermediate transfer belt 10 by a tension spring 22. Furthermore, the belt position detection sensor 15 includes a light source 23 and light-receiving elements 24 that face each other through the slit hole 21b. As illustrated in FIGS. 3A and 3B, the slit hole 21b is formed in a quadrangular shape corresponding to the light-receiving elements 24. Here, as illustrated in FIG. 3B, two light-receiving elements 24 are provided along a sub-scanning direction D (the revolving direction of the intermediate transfer belt 10).

In detail, the contact member 21 is formed in an L shape so as to be rotatable about a rotating shaft. Further, the slit hole 21b includes a rectangular open slit. Furthermore, a contact portion of the contact member 21, which is in contact with the intermediate transfer belt 10, is formed in the shape of a pin. The intermediate transfer belt 10 is in contact with the pin 21a from the right side in FIGS. 2A and 2B. The tension spring 22 is adapted to pull the contact member 21 so as to slightly generate contact pressure.

The slit hole 21b is formed of a rectangular opening that has substantially the same width as the width of the light-receiving area of one of the two light-receiving elements 24. It is possible to determine a range in which the deviation of the intermediate transfer belt 10 (overrun, a belt deviation) based on the width of the slit hole 21b and the total width of the two light-receiving elements 24, and to determine the width of a linear range based on the width of the slit hole 21b. A deviation width in the width direction, which may be generated when the intermediate transfer belt 10 travels (revolves), is detected as the moving distance of the slit hole 21b of the contact member 21 based on the above-mentioned structure by the light-receiving elements 24.

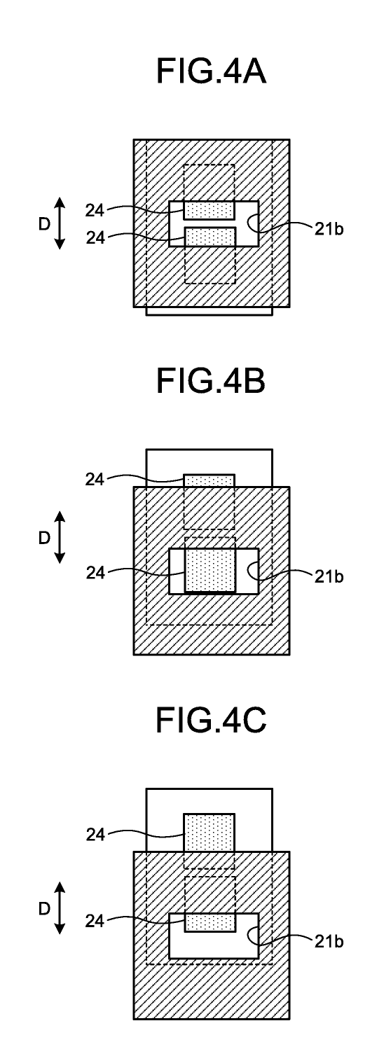

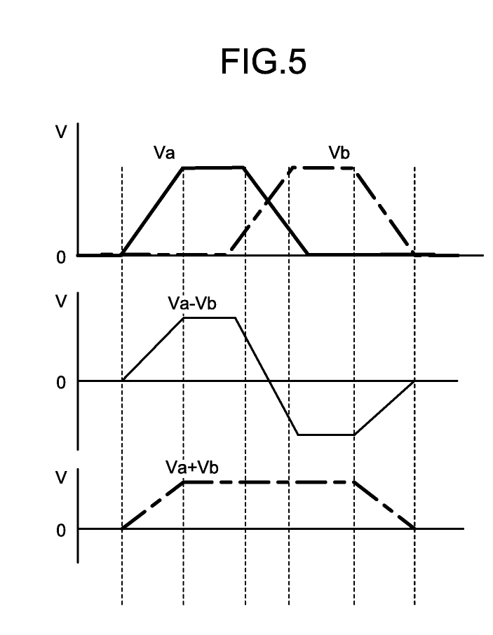

Next, how the belt position detection sensor 15 according to the first embodiment detects a belt deviation will be described. FIGS. 4A to 4C are diagrams illustrating examples of a positional relationship between the slit hole 21b and the light-receiving elements 24 of the belt position detection sensor 15 according to the first embodiment. FIG. 5 is a diagram illustrating changes in output signals that are caused by a change in a positional relationship between the slit hole 21b and the light-receiving elements 24 of the belt position detection sensor 15 according to the first embodiment.

An upper graph of FIG. 5 illustrates changes in voltage signals obtained from the two light-receiving elements 24 in a case in which the two light-receiving elements 24 and the slit hole 21b gradually move relative to each other in the sub-scanning direction D. A case in which the state of the slit hole 21b is changed in the order of a state in which the slit hole 21b overlaps only one light-receiving element 24, a state in which the slit hole 21b overlaps both the light-receiving elements 24, a state in which the slit hole 21b overlaps only the other light-receiving element 24, and a state in which the slit hole 21b does not overlap both the two light-receiving elements 24, from a state in which the slit hole 21b does not overlap both the two light-receiving elements 24 will be considered below. Further, a voltage signal obtained from the light-receiving element 24, which overlaps the slit hole 21b first, (one light-receiving element 24 having been described above) is denoted by Va, and a voltage signal obtained from the light-receiving element 24, which overlaps the slit hole 21b later, (the other light-receiving element 24 having been described above) is denoted by Vb. Furthermore, an intermediate graph of FIG. 5 illustrates a difference (Va−Vb) between the voltage signals Va and Vb illustrated in the upper graph of FIG. 5. Moreover, the lower graph of FIG. 5 illustrates the sum (Va+Vb) of the voltage signals Va and Vb illustrated in the upper graph of FIG. 5.

The graphs of FIG. 5 will be described in order from the left side to the right side. Since the slit hole 21b does not overlap both the two light-receiving elements 24 at first, both the light-receiving elements 24 cannot receive light emitted from the light source 23. However, when the intermediate transfer belt 10 travels to some extent, the slit hole 21b starts to overlap one light-receiving element 24 (see FIG. 4C). Accordingly, at this time, only the voltage signal Va is gradually increased from a state in which all the voltage signals Va and Vb are 0.

Then, as the slit hole 21b is further moved, the voltage signal Va is further increased. When the slit hole 21b and one light-receiving element 24 substantially overlap each other (see FIG. 4B), a change in the voltage signal Va is stopped. After that, when the slit hole 21b is further moved, the slit hole 21b also starts to overlap the other light-receiving element 24 and one light-receiving element 24 is gradually hidden (see FIG. 4A). Accordingly, at this time, a voltage signal Va−Vb is linearly reduced so as to be inclined. Then, when the slit hole 21b is further moved, the voltage signal Va becomes 0 at this time and the voltage signal Vb is not changed. After that, when the slit hole 21b is further moved, both the light-receiving elements 24 also cannot receive light emitted from the light source 23 in the end.

Here, it is said that the positional relationship between the two light-receiving elements 24 and the slit hole 21b is appropriate when the voltage signal Va−Vb is 0. Accordingly, a belt driving device 100, which is adapted to be capable of performing belt deviation correction for correcting a belt position based on the detection result of the belt position detection sensor 15 at the time of startup or the like of the apparatus so that the voltage signal Va−Vb becomes 0, is provided in the first embodiment.

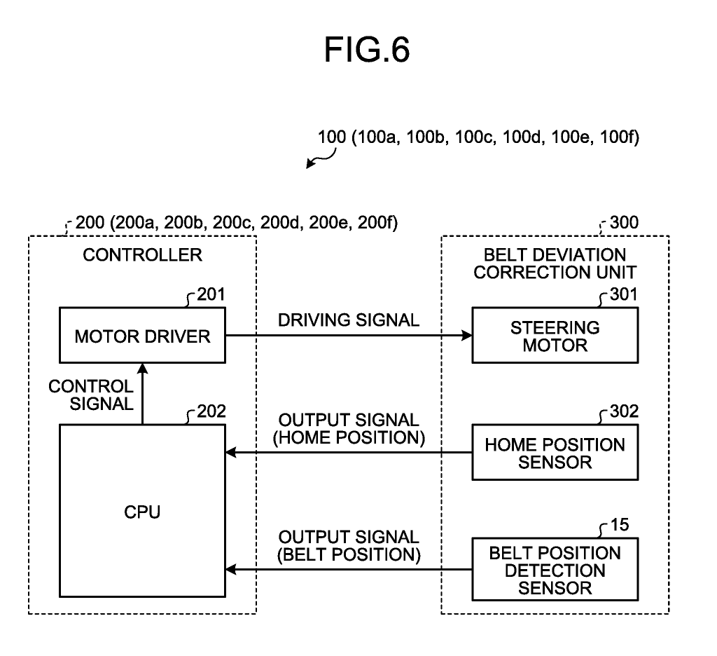

FIG. 6 is a block diagram illustrating the schematic configuration of the belt driving device 100 according to the first embodiment.

As illustrated in FIG. 6, the belt driving device 100 includes a controller 200 and a belt deviation correction unit 300. The controller 200 includes a motor driver 201 and a CPU (Central Processing Unit) 202. Further, the belt deviation correction unit 300 includes a steering motor 301, a home position sensor 302, and the belt position detection sensor 15.

The motor driver 201 is, for example, a stepping motor driver, and outputs a driving signal for driving the steering motor 301 based on a control signal output from the CPU 202. The CPU 202 is adapted to be capable of performing various kinds of arithmetic processing as in the case of a processor that is used in a general computer. For example, the CPU 202 determines a control signal, which is to be output to the steering motor 301, based on an output signal output from the home position sensor 302 and an output signal output from the belt position detection sensor 15.

The steering motor 301 is a driving source that drives the steering roller 16 (see FIG. 1). Further, the home position sensor 302 is a sensor that detects the home position of the steering roller 16, and is formed of, for example, a photointerrupter or the like.

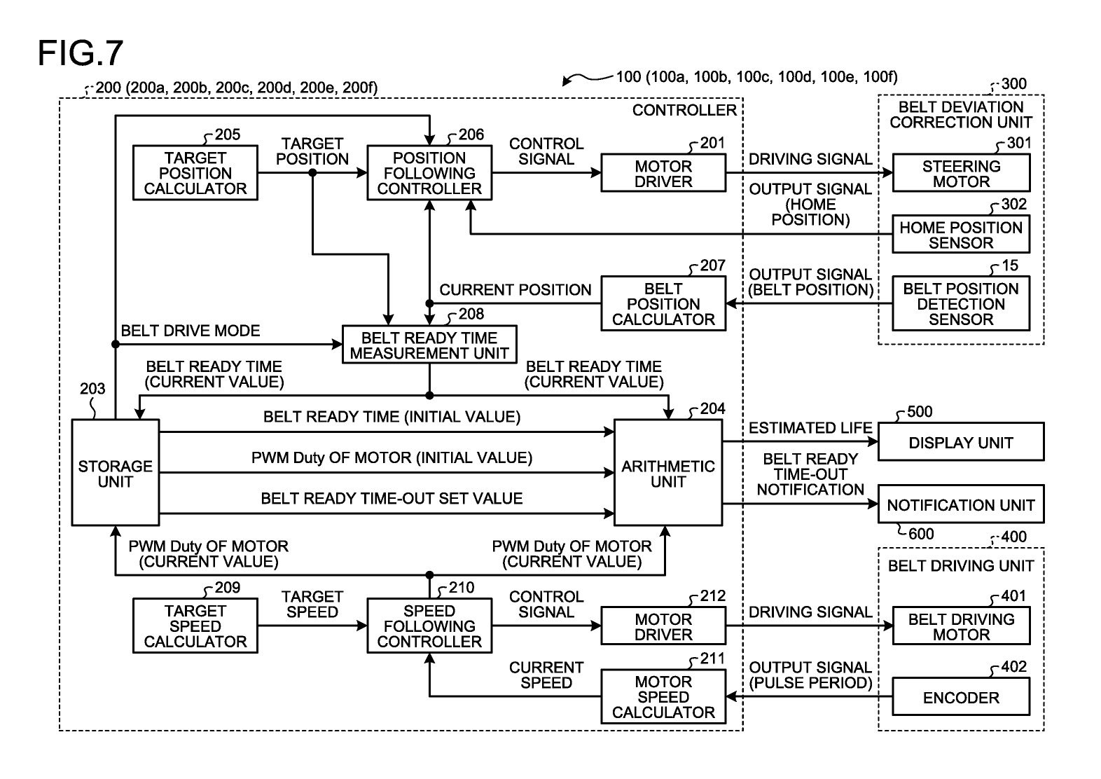

FIG. 7 is a block diagram illustrating the detailed configuration of the belt driving device 100 according to the first embodiment.

As illustrated in FIG. 7, the belt driving device 100 includes a belt driving unit 400, a display unit 500, and a notification unit 600 in addition to the controller 200 and the belt deviation correction unit 300 illustrated in FIG. 6.

The belt driving unit 400 includes a belt driving motor 401 and an encoder 402. The belt driving motor 401 is a driving source that drives the belt driving roller 13 for revolving the intermediate transfer belt 10. The encoder 402 detects the rotational speed of the belt driving roller 13, and outputs pulses with a period corresponding to the detected rotational speed.

The display unit 500 is a display device, such as a display, that is adapted to be capable of displaying (outputting) various kinds of information about the belt driving device 100. The notification unit 600 is a device that notifies a user of various kinds of information about the belt driving device 100 by a method of appealing to the five senses of the user (including a visual method). The notification unit 600 is, for example, a flashing alarm lamp, a speaker, or the like.

The controller 200 includes a storage unit 203, an arithmetic unit 204, a target position calculator 205, a position following controller 206, a belt position calculator 207, a belt ready time measurement unit 208, a target speed calculator 209, a speed following controller 210, a motor speed calculator 211, and a motor driver 212 in addition to the motor driver 201 illustrated in FIG. 6.

Meanwhile, in the first embodiment, the components of the controller 200 except for the motor drivers 201 and 212 may be realized by the combination of software and hardware. That is, in the first embodiment, the components of the controller 200 except for the motor drivers 201 and 212 may be created on a main storage device (not illustrated in FIG. 6) as the results of a predetermined program executed by the CPU 202 illustrated in FIG. 6. However, in the first embodiment, a part of the components of the controller 200 except for the motor drivers 201 and 212 may be realized by only hardware.

The storage unit 203 stores various kinds of information about the belt driving device 100 (belt ready time to be described below and the like) at an arbitrary timing, and outputs the stored information in accordance with a request.

The arithmetic unit 204 performs various kinds of arithmetic processing (processing for calculating an estimated life to be described below, and the like) based on information received from the storage unit 203 and the like; and outputs arithmetic results in accordance with a request.

The target position calculator 205 calculates the target position of the steering motor 301 (corresponding to the target position of the intermediate transfer belt 10 in the width direction), and outputs the calculated target position to the position following controller 206.

The position following controller 206 outputs a control signal to the motor driver 201, which drives the steering motor 301, so that the current position reaches a target position, based on the target position of the intermediate transfer belt 10 in the width direction that is received from the target position calculator 205 and the current position of the intermediate transfer belt 10 in the width direction that is received from the belt position calculator 207.

Meanwhile, when a request for moving the steering roller 16 to the home position (a home position operation request) is generated, the position following controller 206 continues to output a control signal to the motor driver 201 until an output signal output from the home position sensor 302 reaches a predetermined level corresponding to the home position of the steering roller 16.

The belt position calculator 207 calculates the current position of the intermediate transfer belt 10 in the width direction based on an output signal that is output from the belt position detection sensor 15 and includes information representing the current position of the intermediate transfer belt 10 in the width direction; and outputs the calculated current position to the position following controller 206 and the belt ready time measurement unit 208.

The belt ready time measurement unit 208 measures correction time that is taken to correct a belt position, and outputs the measured correction time to the storage unit 203 and the arithmetic unit 204. Meanwhile, correction time is time that is taken until the intermediate transfer belt 10 reaches a target position, that is, time that is taken until the state of the intermediate transfer belt 10 becomes a state in which the operation of the intermediate transfer belt 10 is ready (a belt ready state). The correction time is referred to as belt ready time in the following description.

The target speed calculator 209 calculates the target speed of the belt driving motor 401 (corresponding to the target speed of the intermediate transfer belt 10 in the revolving direction), and outputs the calculated target speed to the speed following controller 210.

The speed following controller 210 outputs a control signal to the motor driver 212, which drives the belt driving motor 401, so that the current speed reaches a target speed, based on the target speed of the intermediate transfer belt 10 in the revolving direction that is received from the target speed calculator 209 and the current speed of the intermediate transfer belt 10 in the revolving direction that is received from the motor speed calculator 211. Meanwhile, the motor driver 212 is, for example, a brushless motor driver.

The motor speed calculator 211 calculates the current speed of the intermediate transfer belt 10 in the revolving direction based on an output signal that is output from the encoder 402 and includes information representing the current speed of the intermediate transfer belt 10 in the revolving direction; and outputs the calculated current speed to the speed following controller 210.

Here, the controller 200 according to the first embodiment calculates an estimated value (estimated failure time, estimated life) of time, which is taken until the operation of the belt driving device 100 is stopped, (for example, until a failure occurs), based on the belt ready time by performing the following processing according to a predetermined program; and makes the calculated estimated life be displayed in the display unit 500.

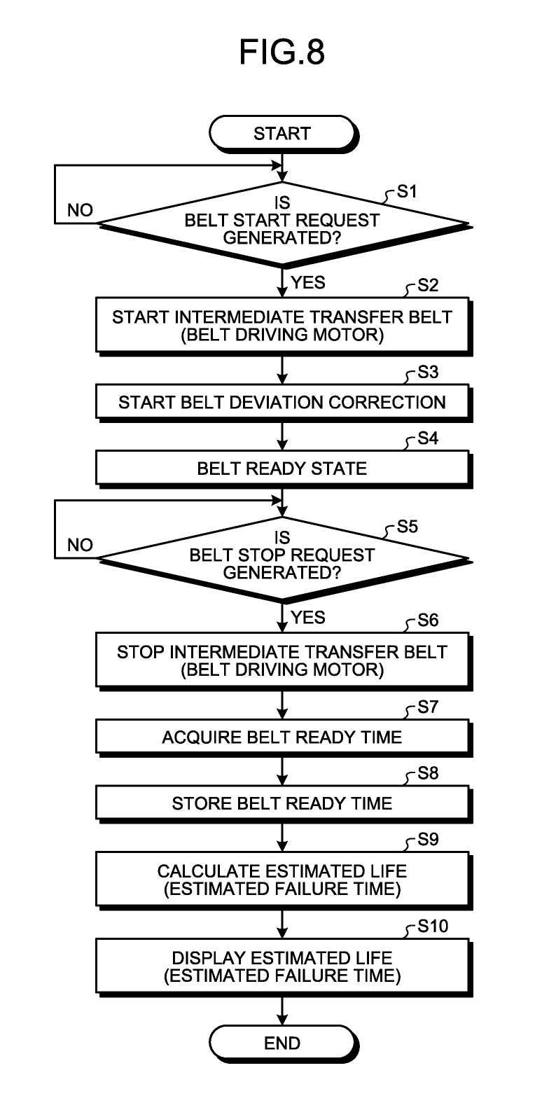

FIG. 8 is a flow chart illustrating processing that is performed by the controller 200 according to the first embodiment.

As illustrated in FIG. 8, first, in step S1, the controller 200 according to the first embodiment determines whether or not a belt start request is generated, that is, whether or not an event serving as a trigger for starting the intermediate transfer belt 10 is generated. The processing of step S1 is repeated until it is determined that a belt start request is generated. Then, if it is determined in step S1 that a belt start request is generated, processing proceeds to step S2.

In step S2, the controller 200 starts the intermediate transfer belt 10 (the belt driving motor 401). Then, processing proceeds to step S3.

In step S3, the controller 200 starts belt deviation correction using the belt deviation correction unit 300. Then, processing proceeds to step S4.

In step S4, the controller 200 completes the belt deviation correction of step S3 and sets the state of the intermediate transfer belt 10 to a belt ready state. The belt ready state is a state in which the position of the intermediate transfer belt 10 in the width direction is corrected to a target position and an image forming operation can be performed. Then, processing proceeds to step S5.

In step S5, the controller 200 determines whether or not a belt stop request is generated, that is, whether or not an event serving as a trigger for stopping the intermediate transfer belt 10 is generated. The processing of step S5 is repeated until it is determined that a belt start request is generated. Then, if it is determined in step S5 that a belt start request is generated, processing proceeds to step S6.

In step S6, the controller 200 stops the intermediate transfer belt 10 (the belt driving motor 401). Then, processing proceeds to step S7.

In step S7, the controller 200 acquires belt ready time that is time taken for the belt deviation correction. Specifically, the arithmetic unit 204 of the controller 200 acquires time that is measured by the belt ready time measurement unit 208 and is taken until the intermediate transfer belt 10 is in the belt ready state after the start of the belt deviation correction. Then, processing proceeds to step S8.

In step S8, the controller 200 stores the belt ready time, which is acquired in step S7, in the storage unit 203. Then, processing proceeds to step S9.

In step S9, the controller 200 calculates the estimated life (estimated failure time) of the intermediate transfer belt 10 based on the belt ready time.

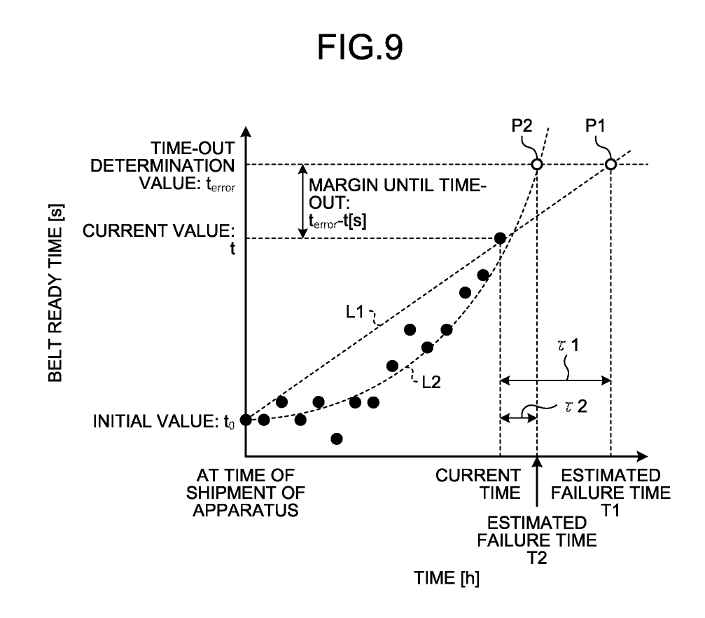

Here, FIG. 9 is a diagram illustrating a method of calculating an estimated life according to the first embodiment. In FIG. 9, a vertical axis represents belt ready time and a horizontal axis represents time elapsed from the shipment of the apparatus. Further, in FIG. 9, fifteen black dots are measured values of belt ready time that are measured at different timings.

Generally, since the components of the belt driving device 100 deteriorate with the lapse of time, a load applied to the belt driving device 100 tends to increase with the lapse of time. Accordingly, the measured values of the belt ready time tend to increase with the lapse of time as illustrated in FIG. 9.

Here, the belt ready time, which is measured at the time of the shipment of the apparatus, is referred to as an initial value t₀, the current belt ready time is referred to as the current value t, and a value, which serves as a reference for the determination of time-out representing that a belt ready state cannot be made within predetermined time, is referred to as a time-out determination value tₑᵣᵣₒᵣ. In this case, tₑᵣᵣₒᵣ−t denotes a margin of time that is taken until the determination of time-out.

Further, the derivation of an approximate line using a measured value of time, which is taken up to the present from the time of the shipment of the apparatus, is considered. In FIG. 9, reference numeral L1 denotes an approximate straight line that is obtained from the approximation of measured values as a straight line based on the initial value t₀, and reference numeral L2 denotes an approximate curve that is obtained from the approximation of measured values as a power curve on the basis including the initial value t₀. The estimated failure time and the estimated life of the belt driving device 100 can be calculated based on these approximate lines.

Specifically, the value of a coordinate P1, at which the value of the approximate straight line L1 on the vertical axis reaches tₑᵣᵣₒᵣ, on the horizontal axis can be calculated as estimated failure time T1 based on the approximate straight line L1; and a time interval between the estimated failure time T1 and the current time can be calculated as estimated life T1 based on the approximate straight line L1. Likewise, the value of a coordinate P2, at which the value of the approximate curve L2 on the vertical axis reaches tₑᵣᵣₒᵣ, on the horizontal axis can be calculated as estimated failure time T2 based on the approximate curve L2; and a time interval between the estimated failure time T2 and the current time can be calculated as estimated life T2 based on the approximate curve L2.

Meanwhile, a method of calculating the approximate line may be an arbitrary method as long as being a method based on the measured values of belt ready time. Further, the estimated failure time and the estimated life may be calculated by an arbitrary method as long as being calculated by a method using a plurality of values obtained from a plurality of approximate lines. For example, an average value of a plurality of values obtained from a plurality of approximate lines may be calculated as the estimated failure time and the estimated life, and the minimum value thereof may be calculated as the estimated failure time and the estimated life.

Returning to FIG. 8, processing proceeds to step S10 after the processing of step S9 is performed. Then, in step S10, the controller 200 displays the estimated life (estimated failure time), which is calculated in step S9, in the display unit 500. After that, processing ends.

As described above, the belt driving device 100 according to the first embodiment includes the belt deviation correction unit 300 that corrects a belt position to a set position (a target position), the controller 200 that calculates the estimated life of the belt driving device 100 based on correction time (belt ready time) taken for the correction of the belt position, and the display unit 500 that outputs (displays) the estimated life. Accordingly, a possibility that the operation of the apparatus (the belt driving device 100 and the image forming apparatus including the belt driving device 100) is stopped can be recognized in advance based on the estimated life. As a result, a possibility that a situation in which the operation of the apparatus is stopped is generated can be estimated in advance, and the stop of the operation of the apparatus at an unexpected timing can be further suppressed.

### Second Embodiment

Next, a second embodiment will be described. The second embodiment is the same as the first embodiment in that estimated life is calculated through the acquisition of belt ready time. However, unlike in the first embodiment, in the second embodiment, a value based on a control signal for the belt driving motor 401 at the time of the performing of belt deviation correction is acquired before the acquisition of belt ready time and whether or not an abnormal load is generated in a belt driving device 100a is determined based on the value. An example in which a duty ratio of a PWM signal serving as a control signal is used as an example of the value based on the control signal will be described below.

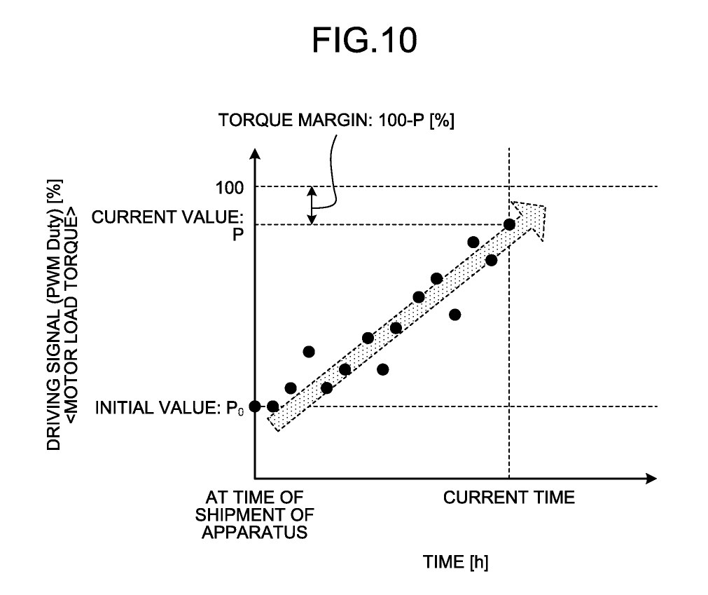

FIG. 10 is a diagram illustrating the time change of a control signal that is used in the second embodiment. In FIG. 10, a vertical axis represents the duty ratio (PWM Duty) of a control signal (PWM signal) for the belt driving motor 401 and a horizontal axis represents time elapsed from the shipment of the apparatus. Further, in FIG. 10, fifteen black dots are measured values of a PWM Duty that are measured at different timings.

Here, a PWM Duty, which is measured at the time of the shipment of the apparatus, is referred to as an initial value P₀ and the current PWM Duty is referred to as the current value P. In this case, 100-P [%] represents the torque margin of the belt driving motor 401.

In order to rotate the belt driving motor 401 at a target speed, a PWM Duty is controlled so that torque corresponding to a load is generated. In the case of the same target speed, a PWM Duty and a load are proportional to each other. For this reason, as illustrated in FIG. 10, the load increases in a case in which the measured values of a PWM Duty tend to increase with the lapse of time.

Here, in a case in which belt ready time tends to increase with the lapse of time (for example, see FIG. 9), an increase in the load of the belt driving motor 401 may be one of causes thereof.

When this is used, the diagnosis of the state of the belt driving device 100a (the determination of whether or not an abnormal load is applied to the belt driving device 100a) can be performed.

Specifically, since the measured values of the PWM Duty are acquired before the acquisition of belt ready time in the second embodiment, it can be determined that an abnormal load is applied to the belt driving device 100a in a case in which a value obtained from the measured values of the PWM Duty exceeds a certain range. Meanwhile, for example, a difference/ratio between the current value P and the initial value P₀, and the maximum value/the minimum value/an average value, and the like of a plurality of measured values are considered as an example of the value obtained from the measured values of the PWM Duty.

Further, since the belt ready time is acquired in the second embodiment even though the value obtained from the measured values of the PWM Duty is within a certain range, it can be determined that an abnormal load is applied to the belt driving device 100a in a case in which the value (see FIG. 9) obtained from the belt ready time exceeds a certain range.

That is, in the second embodiment, whether or not an abnormal load is applied to the belt driving device 100a is determined based on the value obtained from the measured values of the PWM Duty and a value obtained from the belt ready time. Accordingly, it is possible to notify a user (or a service engineer) of the necessity of maintenance in real time.

In this way, a controller 200a (see FIGS. 6 and 7) of the belt driving device 100a according to the second embodiment determines whether or not to acquire belt ready time according to a PWM Duty by performing the following processing according to a predetermined program different from the program of the first embodiment. Further, the controller 200a calculates the estimated life of the belt driving device 100a in a case in which the controller 200a acquires belt ready time.

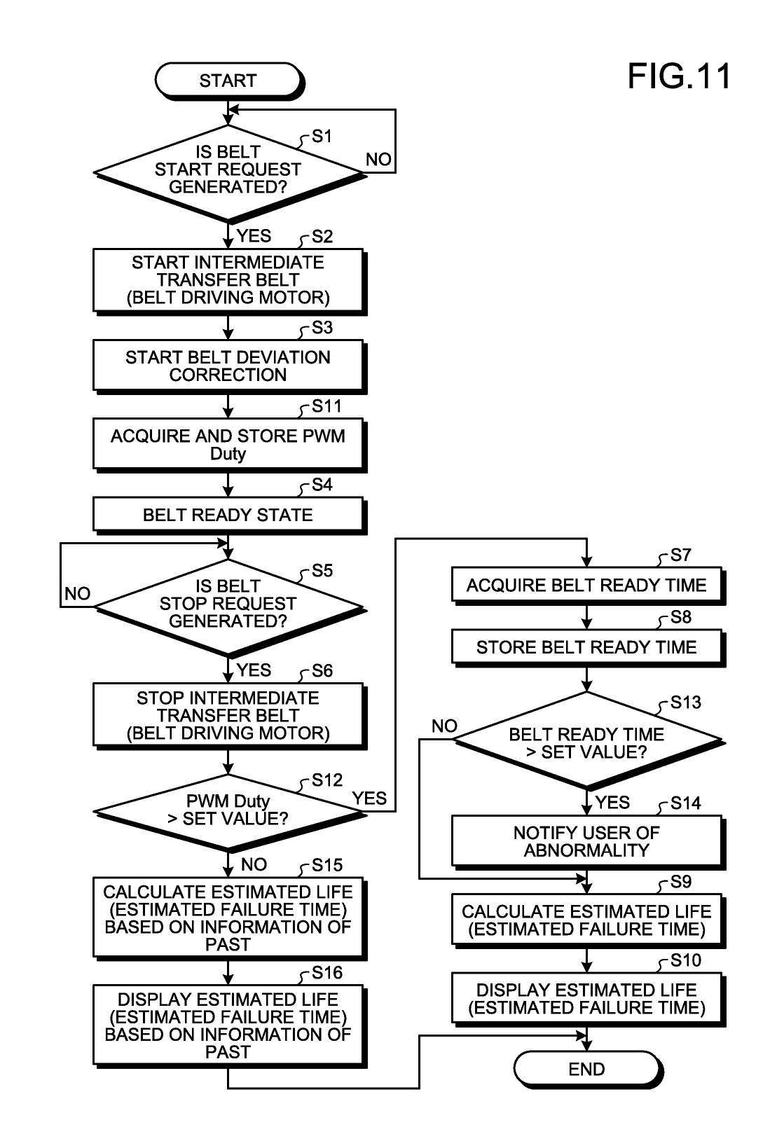

FIG. 11 is a flow chart illustrating processing that is performed by the controller 200a of the belt driving device 100a according to the second embodiment.

First, the same processing of steps S1 to S3 as that of the first embodiment is performed in the second embodiment as illustrated in FIG. 11. However, unlike in the first embodiment, in the second embodiment, processing proceeds to step S11 after the processing of step S3.

In step S11, the controller 200a acquires a value based on a control signal for the belt driving motor 401 at the time of the performing of belt deviation correction, and stores the acquired value in the storage unit 203. Specifically, the value based on a control signal is the duty ratio (PWM Duty) of a PWM signal serving as a control signal.

After the processing of step S11 is performed, the same processing of steps S4 to S6 as that of the first embodiment is performed. Then, processing proceeds to step S12 after the processing of step S6 is performed.

In step S12, the controller 200a determines whether or not the PWM Duty, which is acquired and stored in step S11, is larger than a set value. The set value is a value that is arbitrarily set by a user or the like, and is a value serving as a reference for the determination of whether or not to notify a user of the generation of an abnormal load in the belt driving device 100a.

If it is determined in step S12 that the PWM Duty is larger than the set value, processing proceeds to step S13 after the same processing of steps S7 and S8 as that of the first embodiment is performed.

Then, in step S13, the controller 200a determines whether or not the belt ready time, which is acquired in step S7 and is stored in step S8, is larger than a set value. As in the case of the set value used in step S12, the set value used in step S13 is also a value that is arbitrarily set by a user or the like and is a value serving as a reference for the determination of whether or not to notify a user of the generation of an abnormal load in the belt driving device 100a.

If it is determined in step S13 that the belt ready time is equal to or smaller than the set value, processing ends after the same processing of steps S9 and S10 as that of the first embodiment is performed. On the other hand, if it is determined in step S13 that the belt ready time is larger than the set value, processing proceeds to step S14.

In step S14, the controller 200a outputs abnormality notification, which notifies a user of the generation of an abnormal load in the belt driving device 100a, through the notification unit 600.

After the processing of step S14 is performed, the same processing of steps S9 and S10 as that of the first embodiment is performed and processing ends.

Meanwhile, if it is determined in step S12 that the PWM Duty is equal to or smaller than the set value, processing proceeds to step S15. Then, in step S15, the controller 200a calculates the estimated life (estimated failure time) of the intermediate transfer belt 10 based on information of the past (for example, belt ready time that is recently acquired and stored). After that, in step S16, the controller 200a displays the estimated life (estimated failure time), which is calculated in step S15 and is based on the information of the past, in the display unit 500 and processing ends.

As described above, the controller 200a of the belt driving device 100a according to the second embodiment determines whether or not to acquire belt ready time according to a PWM Duty and calculates the estimated life of the belt driving device 100a in a case in which the controller 200a acquires belt ready time. Accordingly, whether or not an abnormal load is applied to the belt driving device 100a can be easily determined based on the measured value of a PWM Duty.

### Modification of Second Embodiment

Next, a modification of the second embodiment will be described. The modification is the same as the second embodiment in that a PWM Duty is acquired before the acquisition of belt ready time. However, unlike in the second embodiment, in the modification, the oldest PWM Duty is erased from the storage unit 203 (in this regard, an initial value is not erased) whenever a new PWM Duty is acquired.

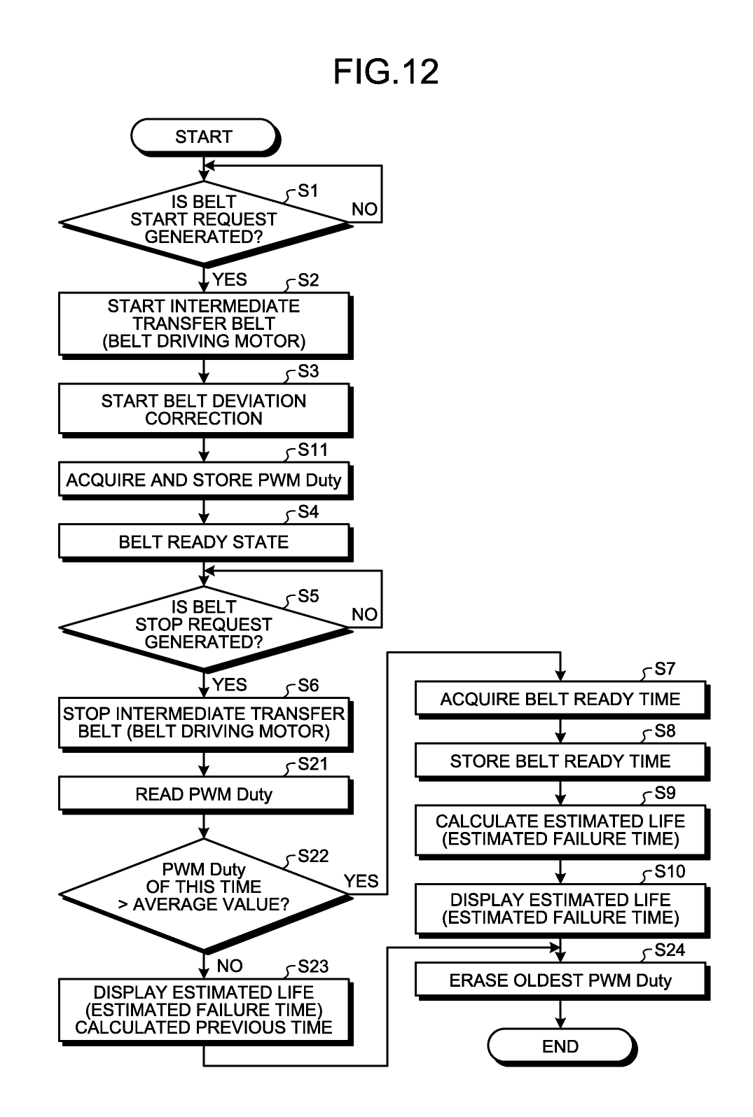

FIG. 12 is a flow chart illustrating processing that is performed by a controller 200b (see FIGS. 6 and 7) of a belt driving device 100b according to a modification of the second embodiment.

First, the same processing of steps S1 to S3, S11, and S4 to S6 as that of the second embodiment is performed in the modification of the second embodiment as illustrated in FIG. 12. However, unlike in the second embodiment, in the modification of the second embodiment, processing proceeds to step S21 after the processing of step S6.

In step S21, the controller 200b reads a PWM Duty, which is acquired and stored this time in step S4, and PWM Duties, which have been acquired and stored in the past, from the storage unit 203. Meanwhile, the number of the PWM Duties of the past, which are to be read, can be arbitrarily set. Then, processing proceeds to step S22.

In step S22, the controller 200b determines whether or not the PWM Duty of this time is larger than an average value of the PWM Duties read in step S21. That is, the controller 200b determines whether or not a value obtained by dividing the PWM Duty of this time by the average value of the PWM Duties read in step S21 is larger than 1.

If it is determined in step S22 that the PWM Duty of this time is equal to or smaller than the average value, processing proceeds to step S23. Then, in step S23, the controller 200b displays the estimated life (estimated failure time), which has been calculated previous time, in the display unit 500. After that, processing proceeds to step S24.

On the other hand, if it is determined in step S22 that the PWM Duty of this time exceeds the average value, not the processing of step S23 but the same processing of steps S7 to S10 as that of the second embodiment is performed and processing proceeds to step S24.

In step S24, the controller 200b erases the oldest PWM Duty from the storage unit 203. Then, processing ends.

As described above, the oldest data, which has been used for the calculation of an average value of PWM Duties, is erased from the storage unit 203 in the modification of the second embodiment. Accordingly, a change in belt ready time (necessary data) can be efficiently observed without being overlooked. Further, since unnecessary data (the oldest data) is not kept while being stored, a lack of the capacity of the storage unit 203 caused by unnecessary data can be suppressed. Moreover, the number of samples of belt ready time to be measured can be increased by the suppression of the lack of the capacity. As a result, the accuracy of the calculation of the estimated life (estimated failure time) of the belt driving device 100b can be improved.

### Third Embodiment

Next, a third embodiment will be described. The third embodiment is the same as the first embodiment in that estimated life is calculated based on belt ready time. However, unlike in the first embodiment, in the third embodiment, a controller calculates estimated life in consideration of a change in belt ready time that may be generated according to a difference between a belt drive mode at the time of drive of the intermediate transfer belt 10 of previous time and a belt drive mode at the time of drive of the intermediate transfer belt 10 of this time.

The belt drive mode is, for example, a print mode in a case in which the image forming apparatus functions as a printing apparatus. Generally, in a case in which the image forming apparatus functions as a printing apparatus, the printing apparatus is adapted to be capable of performing printing in a plurality of print modes having different qualities. In this case, the position of the steering roller 16 at which the intermediate transfer belt 10 is stabilized varies in every print mode (belt drive mode). The position of the steering roller 16 at which the intermediate transfer belt 10 is stabilized will be referred to as a belt stabilization position in the following description.

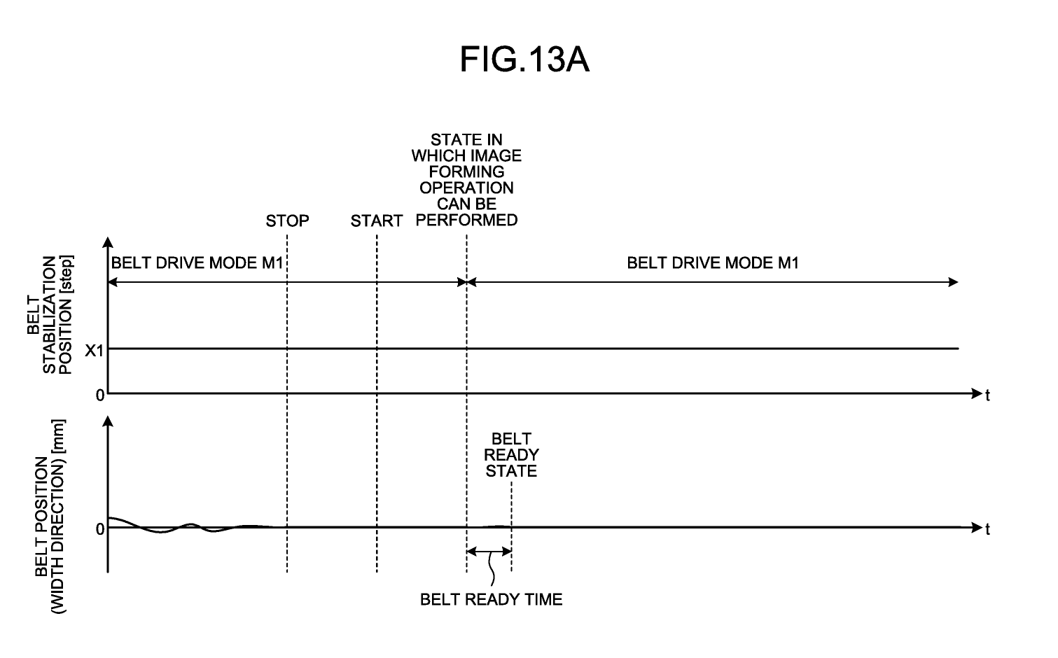

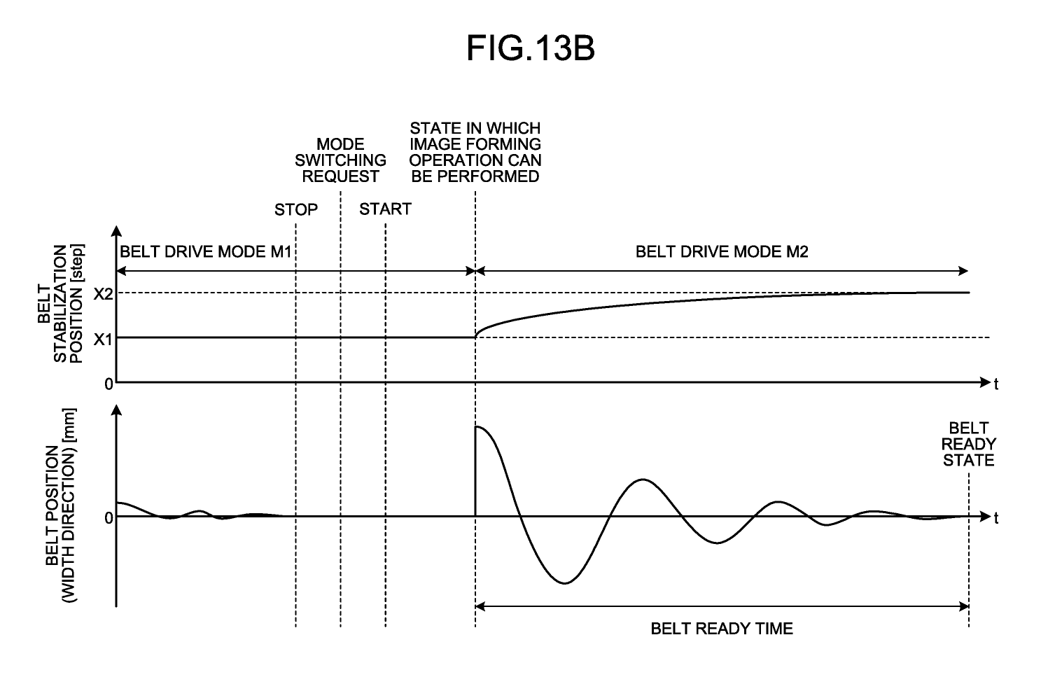

FIG. 13A is a diagram illustrating an example of belt ready time in a case in which a belt drive mode is not changed from the time of drive of previous time in the third embodiment. Further, FIG. 13B is a diagram illustrating an example of belt ready time in a case in which a belt drive mode is changed from the time of drive of previous time in the third embodiment. In FIGS. 13A and 13B, a horizontal axis represents time and a vertical axis represents a belt stabilization position, which is represented by the number of steps from the home position of the steering motor 301, and a belt position. The target position of a belt position will be described as 0 in the following description.

FIG. 13A illustrates the time course of a belt position and a belt stabilization position in a case in which a belt drive mode is not switched, that is, in a case in which the intermediate transfer belt 10 is stopped from the driving state of the intermediate transfer belt 10 of a belt drive mode M1 and is started in the belt drive mode M1 again. When the intermediate transfer belt 10 and the photoconductor drums 2a to 2d used in the belt drive mode M1 come into contact with each other and are in a state in which an image forming operation can be performed, a belt position is present substantially at a target position as illustrated in FIG. 13A due to belt deviation correction at the time of drive of previous time. Accordingly, the state of the intermediate transfer belt 10 instantly becomes a belt ready state. Belt ready time in this case corresponds to, for example, a sampling period, time that is taken for the intermediate transfer belt 10 to make one revolution, and the like.

On the other hand, FIG. 13B illustrates the time course of a belt position and a belt stabilization position in a case in which a belt drive mode is switched, that is, in a case in which the intermediate transfer belt 10 is stopped from the driving state of the intermediate transfer belt 10 of a belt drive mode M1, receives a request for switching a mode to a belt drive mode M2, and is started in the belt drive mode M2. Since a belt stabilization position is changed before and after the switching of a belt drive mode as illustrated in FIG. 13B, a belt position deviates from a target position when the intermediate transfer belt 10 and the photoconductor drums 2a to 2d used in the belt drive mode M2 come into contact with each other and are in a state in which an image forming operation can be performed. Since belt deviation correction is performed in a state in which a belt position deviates as described above, a belt position converges to a target position. Accordingly, in a case in which a belt drive mode is switched, time, which is taken until the state of the intermediate transfer belt 10 becomes a belt ready state, is long in comparison with a case in which a belt drive mode is not switched.

Accordingly, a controller 200c (see FIGS. 6 and 7) of a belt driving device 100c according to the third embodiment calculates estimated life in consideration of a change in belt ready time, which may be generated according to a difference between a belt drive mode at the time of drive of previous time and a belt drive mode at the time of drive of this time, by performing the following processing. Specifically, the controller 200c according to the third embodiment corrects belt ready time, which is measured this time, in consideration of a change in belt ready time that may be generated according to a difference between a belt drive mode at the time of drive of previous time and a belt drive mode at the time of drive of this time; and calculates estimated life based on the corrected belt ready time.

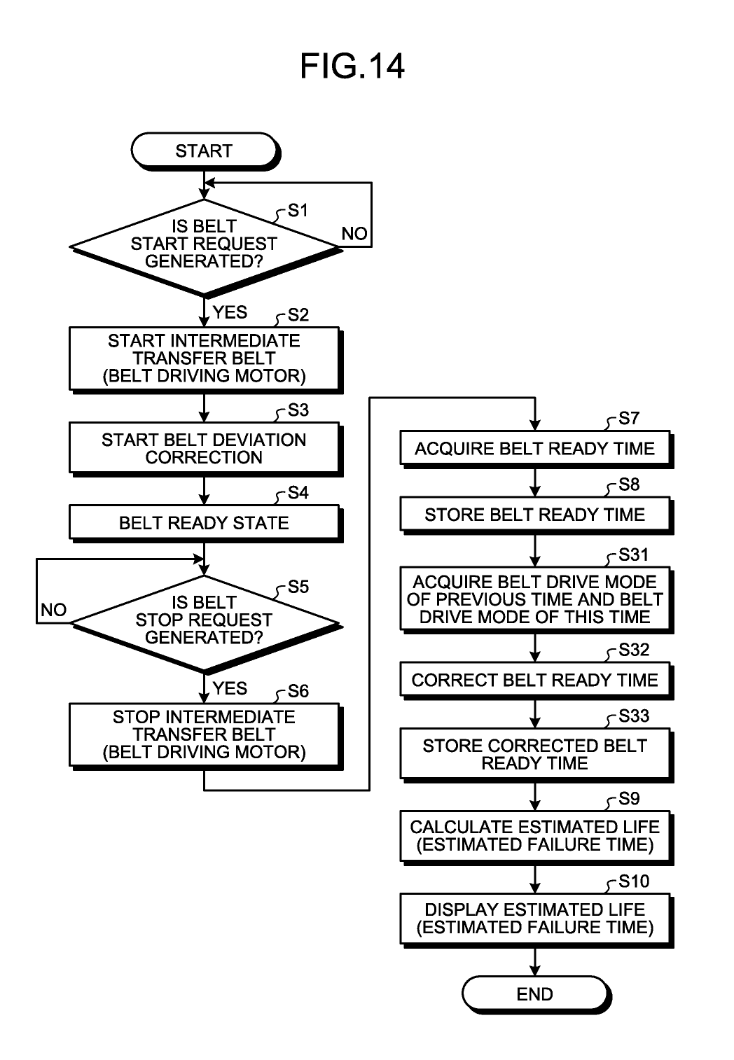

FIG. 14 is a flow chart illustrating processing that is performed by the controller 200c of the belt driving device 100c according to the third embodiment.

First, the same processing of steps S1 to S8 as that of the first embodiment is performed in the third embodiment as illustrated in FIG. 14. However, unlike in the first embodiment, in the third embodiment, processing proceeds to step S31 after the processing of step S8.

In step S31, the controller 200c acquires a belt drive mode of previous time and a belt drive mode of this time. Meanwhile, the storage unit 203 stores which modes the belt drive mode of previous time and the belt drive mode of this time are. Then, processing proceeds to step S32.

In step S32, the controller 200c corrects belt ready time according to the result of step S31. As described above, belt ready time may be significantly changed depending on whether or not a belt drive mode is switched. Accordingly, in step S32, the controller 200c corrects belt ready time by switching and using a plurality of correction factors, which are set in advance, according to a combination of the belt drive mode of previous time and the belt drive mode of this time. Then, processing proceeds to step S33.

In step S33, the controller 200c stores belt ready time, which has been corrected in step S32, in the storage unit 203.

After the processing of step S33 is performed, the same processing of steps S9 and S10 as that of the first embodiment is performed and processing ends.

As described above, the controller 200c of the belt driving device 100c according to the third embodiment calculates estimated life in consideration of a change in belt ready time that may be generated according to a difference between a belt drive mode at the time of drive of previous time and a belt drive mode at the time of drive of this time. Accordingly, the accuracy of the calculation of estimated life can be improved.

### Modification of Third Embodiment

Next, a modification of the third embodiment will be described. The modification is the same as the third embodiment in that a controller calculates estimated life in consideration of a change in belt ready time that may be generated according to a difference between a belt drive mode at the time of drive of previous time and a belt drive mode at the time of drive of this time. However, unlike in the third embodiment, in the modification, a controller classifies measured values of belt ready time by every combination of a belt drive mode before measurement and a belt drive mode after measurement and calculates estimated life based on a group of belt ready time at which the combinations are the same.

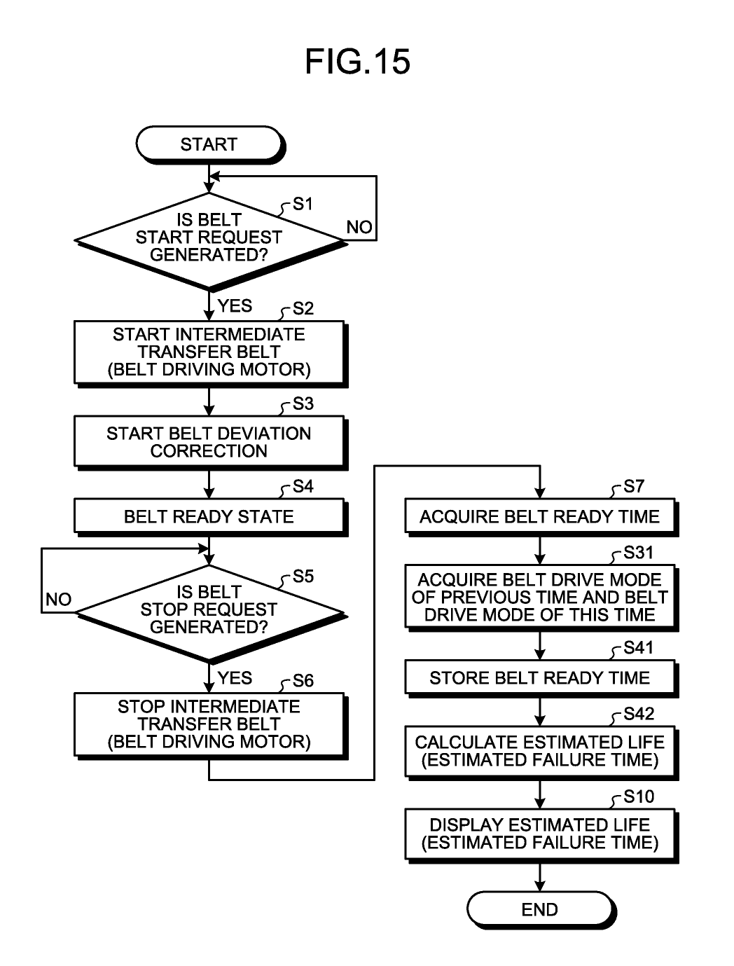

FIG. 15 is a flow chart illustrating processing that is performed by a controller 200d (see FIGS. 6 and 7) of a belt driving device 100d according to the modification of the third embodiment.

First, the same processing of steps S1 to S7 and S31 as that of the third embodiment is performed in the modification of the third embodiment as illustrated in FIG. 15. However, unlike in the third embodiment, in the modification of the third embodiment, processing proceeds to step S41 after the processing of step S31.

In step S41, the controller 200d stores belt ready time, which is measured this time, in the storage unit 203. Here, in the modification of the third embodiment, belt ready time is stored in the storage unit 203 in association with modes to which a belt drive mode is switched before and after the measurement of the belt ready time (or a belt drive mode is not switched before and after the measurement of the belt ready time). That is, in the modification of the third embodiment, the storage unit 203 is divided into areas according to the switching pattern (also including a pattern in which a belt drive mode is not switched) of a belt drive mode. Accordingly, in step S41, the controller 200d stores belt ready time, which is measured this time, in an area, which corresponds to a combination of the belt drive mode acquired in step S31, of a plurality of areas of the storage unit 203. Then, processing proceeds to step S42.

In step S42, the controller 200d calculates estimated life (estimated failure time) based on a plurality of belt ready times stored in the area for the processing of step S41. That is, in step S42, the controller 200d calculates estimated life (estimated failure time) based on a plurality of belt ready times measured under the same condition in regard to the switching pattern (also including a pattern in which a belt drive mode is not switched) of a belt drive mode.

After the processing of step S42 is performed, the same processing of step S10 as that of the third embodiment is performed. Then, processing ends.

As described above, even in the modification of the third embodiment, as in the third embodiment, estimated life is calculated in consideration of a change in belt ready time that may be generated according to a difference between a belt drive mode at the time of drive of previous time and a belt drive mode at the time of drive of this time. Accordingly, the accuracy of the calculation of estimated life can be improved.

### Fourth Embodiment

Next, a fourth embodiment will be described. The fourth embodiment is the same as the first embodiment in that estimated life is calculated based on belt ready time. However, unlike in the first embodiment, in the fourth embodiment, a controller measures belt ready time, which is obtained immediately after maintenance, immediately after maintenance (at the time of first start after maintenance) and determines the effect of maintenance based on the measured belt ready time.

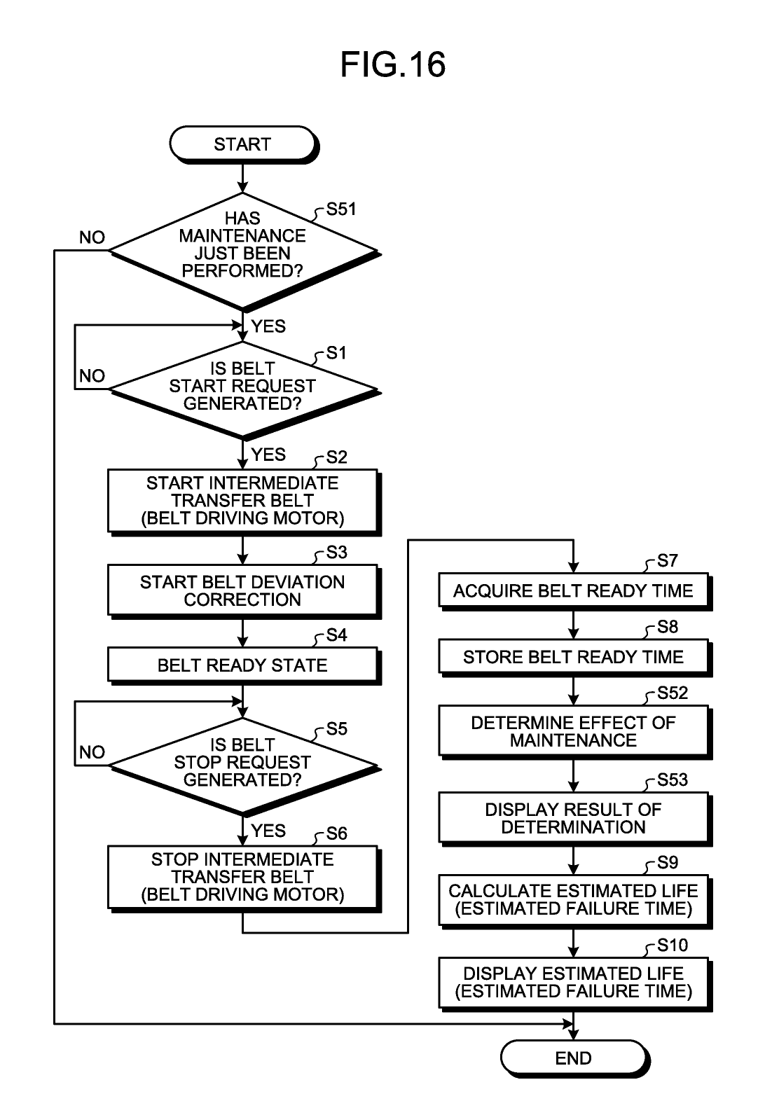

FIG. 16 is a flow chart illustrating processing that is performed by a controller 200e (see FIGS. 6 and 7) of a belt driving device 100e according to the fourth embodiment.

As illustrated in FIG. 16, in the fourth embodiment, unlike in the first embodiment, first, in step S51, the controller 200e determines whether the maintenance of the belt driving device 100e has just been performed, that is, whether or not the belt driving device 100e is started for the first time after maintenance.

If it is determined in step S51 that the maintenance of the belt driving device 100e has not just been performed, processing ends. On the other hand, if it is determined in step S51 that the maintenance of the belt driving device 100e has just been performed, the same processing of steps S1 to S8 as that of the first embodiment is performed and processing proceeds to step S52.

In step S52, the controller 200e determines the effect of maintenance by comparing belt ready time, which is measured this time, with belt ready time, which is measured previous time (before maintenance). For example, when belt ready time, which is measured this time, is denoted by tₙ, belt ready time, which is measured previous time, is denoted by tₙ₋₁, and belt ready time at the time of the shipment of the apparatus is denoted by t₀, the controller 200e calculates “(tₙ−t₀)/(tₙ₋₁/t₀)” as a determination value used for determination. Then, the controller 200e determines the effect of maintenance in stages by comparing the determination value, which is calculated in this way, with a plurality of thresholds. For example, when determining the effect of maintenance in three stages, the controller 200e determines that the effect of maintenance is large in a case in which the determination value is smaller than 0.4, determines that the effect of maintenance is intermediate in a case in which the determination value is 0.4 or more and smaller than 0.8, and determines that the effect of maintenance is small in a case in which the determination value is 0.8 or more. Meanwhile, thresholds, such as 0.4 and 0.8, mentioned here are merely exemplary, and the threshold can be arbitrarily set.

After the processing of step S52 is performed, processing proceeds to step S53. Then, in step S53, the controller 200e displays the result of the determination of step S52 in the display unit 500.

After the processing of step S53 is performed, the same processing of steps S9 and S10 as that of the first embodiment is performed and processing ends.

As described above, the controller 200e of the belt driving device 100e according to the fourth embodiment determines the effect of maintenance based on belt ready time that is obtained immediately after the maintenance of the belt driving device 100e is performed (at the time of first start after maintenance). Then, the display unit 500 according to the fourth embodiment outputs (displays) the result of the determination (the effect of maintenance). Accordingly, a user can easily confirm the effect of maintenance.

### Fifth Embodiment

Next, a fifth embodiment will be described. The fifth embodiment is the same as the first embodiment in that the correction of a belt position is started by the steering roller 16 or the like at the time of the start of the intermediate transfer belt 10. However, unlike in the first embodiment, in the fifth embodiment, the correction of a belt position is started after the position of the steering roller 16 is moved to a belt stabilization position corresponding to a belt drive mode at the time of drive of this time in a case in which a belt drive mode at the time of drive of the intermediate transfer belt 10 of previous time is different from a belt drive mode at the time of drive of the intermediate transfer belt 10 of this time.

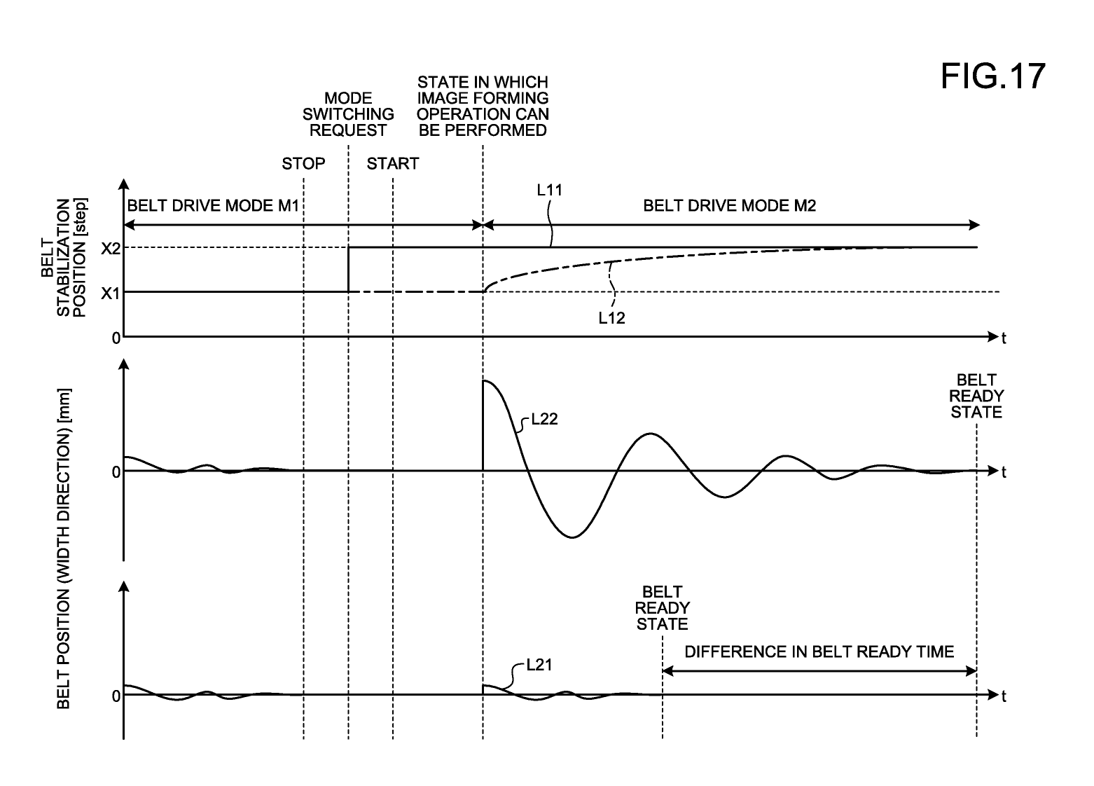

FIG. 17 is a diagram illustrating the movement of a belt position to a belt stabilization position that is performed in a fifth embodiment. In FIG. 17, a horizontal axis represents time and a vertical axis represents a belt stabilization position, which is represented by the number of steps from the home position of the steering motor 301, and a belt position. The target position of a belt position will be described as 0 in the following description.

In FIG. 17, an upper graph L11 of a solid line and a lower graph L21 illustrate a belt stabilization position and the time course of a belt position in a case in which a belt drive mode is switched and the characteristic operation of the fifth embodiment (the movement of a belt stabilization position before the correction of a belt position) is performed. On the other hand, in FIG. 17, an upper graph L12 of a one-dot chain line and an intermediate graph L22 illustrate a belt stabilization position and the time course of a belt position in a case in which a belt drive mode is switched and the characteristic operation of the fifth embodiment is not performed (that is, the same case as the above-mentioned case of FIG. 13B). Meanwhile, in FIG. 17, reference numeral X1 denotes a belt stabilization position in a belt drive mode M1 and reference numeral X2 denotes a belt stabilization position in a belt drive mode M2.

As illustrated by the graphs L11 and L21 of FIG. 17, in the fifth embodiment, the steering roller 16 is moved to a belt stabilization position X2, which corresponds to a switched belt drive mode (a belt drive mode of this time) M2, before the correction of a belt position is performed, more specifically, when a request for switching a mode is received. Accordingly, the steering roller 16 has been already moved to the belt stabilization position X2, which corresponds to the belt drive mode M2, at the time of restart (at the time of drive of this time). Accordingly, after that, the speed control or the like of the intermediate transfer belt 10 is completed, and a belt position has been already present at a position close to a target position when the intermediate transfer belt 10 and the photoconductor drums 2a to 2d used in the belt drive mode M2 come into contact with each other and are in a state in which an image forming operation can be performed. Therefore, the state of the intermediate transfer belt 10 instantly becomes a belt ready state.

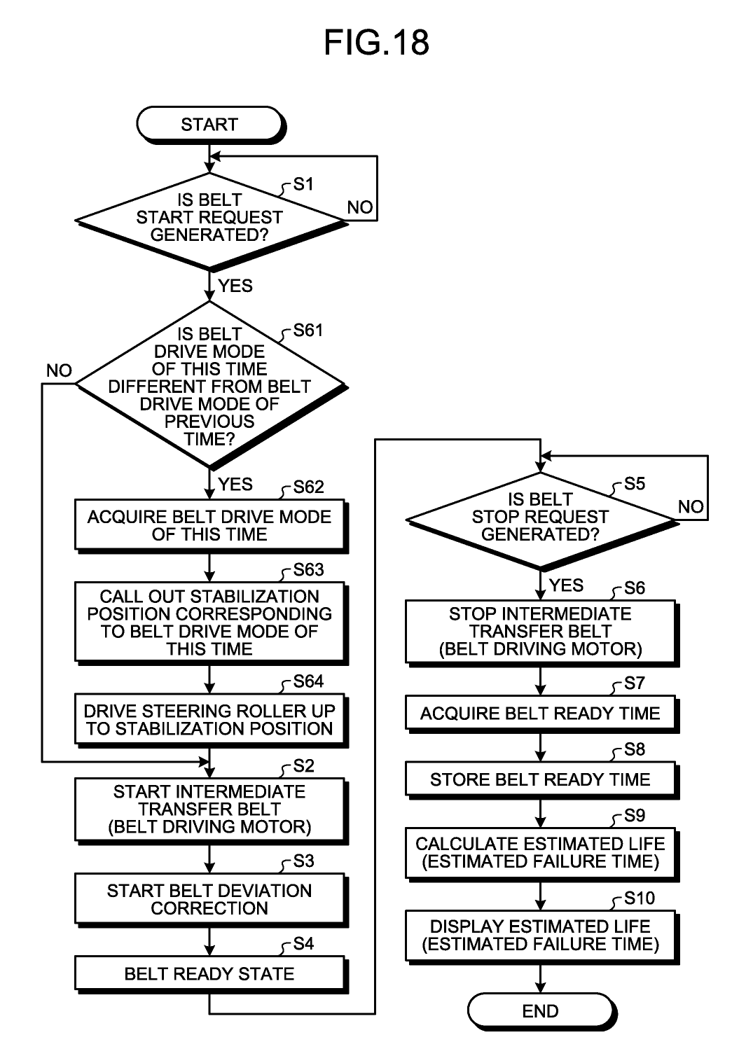

FIG. 18 is a flow chart illustrating processing that is performed by a controller 200f (see FIGS. 6 and 7) of a belt driving device 100f according to the fifth embodiment.

First, the same processing of step S1 as that of the first embodiment is performed in the fifth embodiment as illustrated in FIG. 18. However, unlike in the first embodiment, in the fifth embodiment, processing proceeds to step S61 if it is determined in step S1 that a belt start request is generated.

In step S61, the controller 200f determines whether or not a belt drive mode of this time is different from a belt drive mode of previous time. If it is determined in step S61 that a belt drive mode of this time is the same as a belt drive mode of previous time, the same processing of steps S2 to S10 as that of the first embodiment is performed and processing ends. On the other hand, if it is determined in step S61 that a belt drive mode of this time is different from a belt drive mode of previous time, processing proceeds to step S62.

In step S62, the controller 200f acquires a belt drive mode of this time from the storage unit 203. Then, processing proceeds to step S63.

In step S63, the controller 200f calls out a belt stabilization position corresponding to a belt drive mode of this time. Then, processing proceeds to step S64.

In step S64, the controller 200f drives the steering roller 16 up to a belt stabilization position.

After the processing of step S64 is performed, the same processing of steps S2 to S10 as that of the first embodiment is performed and processing ends.

As described above, the belt deviation correction unit 300 of the belt driving device 100f according to the fifth embodiment is operated as described below based on the control of the controller 200f. That is, the belt deviation correction unit 300 according to the fifth embodiment starts the correction of a belt position after moving the position of the steering roller 16 to a belt stabilization position corresponding to a belt drive mode at the time of drive of this time in a case in which a belt drive mode at the time of drive of previous time is different from a belt drive mode at the time of drive of this time. Accordingly, even when a belt drive mode is switched, belt ready time can be shortened as in a case in which a belt drive mode is not switched.

Meanwhile, when a target speed or a load is the same, belt ready time does not nearly depend on whether or not a belt drive mode is switched. For this reason, according to the fifth embodiment, it is not necessary to manage the data of belt ready time according to whether or not a belt drive mode is switched. Accordingly, the capacity of the storage unit 203 to be used can be reduced. In addition, since the number of samples of belt ready time to be measured can be increased by the capacity of the storage unit to be used that can be reduced, the accuracy of the calculation of the estimated life (estimated failure time) of the belt driving device 100f can be improved.

Programs, which are executed in the belt driving devices according to the above-mentioned first to fifth embodiments (including modifications), are provided so as to be incorporated in a ROM or the like in advance. The program may be provided as a file, which can be installed or executed, in a state in which the program is recorded in a recording medium, which can be read by a computer, such as a CD-ROM, a flexible disk (FD), a CD-R, or a DVD (Digital Versatile Disk).

Further, the program may be provided so as to be stored on a computer connected to a network, such as the Internet and so as to be downloaded from the computer through the network.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A belt driving device that drives an endless belt, the belt driving device comprising:
circuitry configured to
correct a belt position, which is the position of the endless belt in a width direction, to a set position;
calculate an estimated life of the belt driving device based on correction time taken for the correction of the belt position; and
output the estimated life.

2. The belt driving device according to claim 1, wherein
the circuitry determines whether or not to acquire the correction time according to a value based on a control signal for a driving motor serving as a driving source, which revolves the endless belt, and calculates the estimated life in a case in which the correction time is acquired.

3. The belt driving device according to claim 1, wherein
the circuitry calculates the estimated life in consideration of a change in the correction time that is generated according to a difference between a drive mode at the time of drive of the endless belt of previous time and a drive mode at the time of drive of the endless belt of this time.

4. The belt driving device according to claim 1, wherein
the circuitry notifies a user of abnormality in a case in which the correction time is larger than a set value, and
the set value is capable of being arbitrarily set by the user.

5. The belt driving device according to claim 1, wherein
the circuitry outputs the effect of maintenance based on the correction time that is obtained immediately after the maintenance of the belt driving device is performed.

6. The belt driving device according to claim 1, wherein
the circuitry starts the correction of the belt position after moving the position of a correction roller, which is used for the correction of the belt position, to a stabilization position at which the position of the endless belt in a width direction is stabilized and which corresponds to a drive mode at the time of drive of this time in a case in which a drive mode at the time of drive of the endless belt of previous time is different from a drive mode at the time of drive of the endless belt of this time.

7. An image forming apparatus including the belt driving device according to claim 1.

8. A method that is performed by a belt driving device that includes circuitry and drives an endless belt, the method comprising:
correcting a belt position, which is the position of the endless belt in a width direction, to a set position, by the circuitry;
calculating an estimated life of the belt driving device based on correction time, which is taken for the correction of the belt position, by the circuitry; and
outputting the estimated life by the circuitry.

9. A non-transitory computer-readable recording medium that contains a computer program that causes a computer of a belt driving device, which drives an endless belt, to execute:
correcting a belt position, which is the position of the endless belt in a width direction, to a set position,
calculating an estimated life of the belt driving device based on correction time, which is taken for the correction of the belt position, and
outputting the estimated life.
